(19) United States
(12) Patent Application Publication
(10) Pub. No.: US 2012/0109877 A1
(43) Pub. Date: May 3, 2012

(54) Character String Aggregation in Numerical Aggregation

(75) Inventors: Shigeki Takeuchi, Yokohama-shi (JP); Yasuyuki Tominaga, Saitama-shi (JP); Naomi Zenge, Tokyo (JP)

(73) Assignee: INTERNATIONAL BUSINESS MACHINES CORPORATION, Armonk, NY (US)

(21) Appl. No.: 13/269,806

(22) Filed: Oct. 10, 2011

(30) Foreign Application Priority Data
Nov. 2, 2010 (JP) 2010-246299

(51) Int. Cl. G06F 7/00

(52) U.S. Cl. 707/601; 707/600; 707/E17.056

(57) ABSTRACT

A method includes preparing a character string management table for managing character strings, a character string field, and a numerical field corresponding to the character string field in hierarchy structure data of a MOLAP, generating, in response to character string data being input into the character string field, a unique character string ID for a character string of the character string data and storing the character string ID into the numerical field, storing the character string ID and the character string data into the character string management table, calculating an aggregated value of the numerical fields by the numerical aggregation calculation of the MOLAP at a higher hierarchy layer of the hierarchy structure data, resolving the aggregated value into separate character string IDs at the higher hierarchy layer, and referring to the character string management table to obtain and display character string data corresponding to the resolved character string IDs.

### CROSS-REFERENCE TO RELATED APPLICATIONS

This application claims priority to Japanese Patent Application No. 2010-246299, filed Nov. 2, 2010, and all the benefits accruing therefrom under 35 U.S.C. §119, the contents of which in its entirety are herein incorporated by reference.

### BACKGROUND

As one form of OLAP (On-line Analytical Processing) systems for analyzing a database, attention has been paid to MOLAP (Multi-dimensional On-line Analytical Processing) for analyzing a multi-dimensional database especially in companies. In the MOLAP, summary information generated from accumulated data is stored in a multi-dimensional database on the server side, and data is sliced and sent out in response to a processing request from a client.

The MOLAP enables high-speed aggregation calculation/multi-dimensional analysis of numerical data. For example, IBM Cognos TM1™ and IBM CognosExpress™ are known as products used for solutions for budget planning and the like. While being good at numerical aggregation, the MOLAP has a disadvantage that it is not possible to aggregately display character strings.

A technique for operating a natural language in a multi-dimensional database is disclosed in Japanese Patent Laid-Open No. 2004-46394 with a title of “MULTI-DIMENSIONAL DATABASE SYSTEM USING NATURAL LANGUAGE, AND OPERATION INSTRUCTION TRANSLATION METHOD”. In the multi-dimensional database, an operation instruction described in a natural language is interpreted at a part-of-speech level. However, a technique for performing character string aggregation on the multi-dimensional database is not disclosed.

A technique for performing character analysis in a multi-dimensional database is disclosed in Japanese Patent Laid-Open No. 2004-252797 with a title of “METHOD AND SYSTEM FOR PREPARING ANALYSIS INFORMATION ABOUT MULTI-DIMENSIONAL ANALYSIS”. In this technique, axis information used for analysis by the first analyzer is kept together with a keyword input for the analysis so that the next and subsequent analyzers can input the keyword to use the analysis axis information on the basis thereof. However, a technique for performing character string aggregation on a multi-dimensional database is not disclosed.

### BRIEF SUMMARY

According to one embodiment of the present invention, a method for aggregating character strings using numerical aggregation calculation of MOLAP by computer processing, includes preparing a character string management table for managing character strings, and a character string field and a numerical field corresponding to the character string field in hierarchy structure data of the MOLAP, generating, in response to character string data being input into the character string field, a unique character string ID for a character string of the character string data and storing the character string ID into the numerical field, storing the character string ID and the character string data into the character string management table, calculating an aggregated value of the numerical fields by the numerical aggregation calculation of the MOLAP at a higher hierarchy layer of the hierarchy structure data, resolving the aggregated value into separate character string IDs at the higher hierarchy layer, and referring to the character string management table to obtain and display character string data corresponding to the resolved character string IDs.

According to another embodiment of the present invention, a system for aggregating character strings using numerical aggregation calculation of Multi-dimensional On-line Analytical Processing (MOLAP) by computer processing, the system includes a display, and a processor unit operative to prepare, a character string management table for managing character strings, and a character string field and a numerical field corresponding to the character string field in hierarchy structure data of the MOLAP, generate, in response to character string data being input into the character string field, a unique character string ID for a character string of the character string data and storing the character string ID into the numerical field, store the character string ID and the character string data into the character string management table, calculate an aggregated value of the numerical fields by the numerical aggregation calculation of the MOLAP at a higher hierarchy layer of the hierarchy structure data, resolve the aggregated value into separate character string IDs at the higher hierarchy layer, and refer to the character string management table to obtain character string data corresponding to the resolved character string IDs, and output the character string data corresponding to the resolved character string IDs to the display.

According to yet another embodiment of the present invention, a computer program product for causing a computer to aggregate character strings using numerical aggregation calculation of Multi-dimensional On-line Analytical Processing (MOLAP), the computer program product includes a computer readable storage medium having computer readable program code embodied therewith, the computer readable program code comprising computer readable program code to prepare a character string management table for managing character strings, and a character string field and a numerical field corresponding to the character string field in hierarchy structure data of the MOLAP, computer readable program code to generate, in response to character string data being input into the character string field, a unique character string ID for a character string of the character string data and storing the character string ID into the numerical field, computer readable program code to store the character string ID and the character string data into the character string management table, computer readable program code to calculate an aggregated value of the numerical fields by the numerical aggregation calculation of the MOLAP at a higher hierarchy layer of the hierarchy structure data, computer readable program code to resolve the aggregated value into separate character string IDs at the higher hierarchy layer, and computer readable program code to refer to the character string management table to obtain and display character string data corresponding to the resolved character string IDs.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

FIG. 1 is a diagram showing the outline of MOLAP;

FIG. 2 is a diagram showing the state of the sum total of cells of the MOLAP being calculated;

FIG. 3 is a diagram showing restrictions on character string aggregation;

FIG. 4 is a diagram showing restrictions on character string aggregation;

FIG. 5 is a diagram showing restrictions on character string aggregation;

FIG. 6 is a diagram showing restrictions on character string aggregation;

FIG. 7 shows the structure of a character string management table;

FIG. 8 is a diagram showing the case where a character string is input at a lower hierarchy layer;

FIG. 9 shows an example of displaying character strings at a higher hierarchy layer;

FIG. 10 is a diagram showing change of the character string at the lower hierarchy layer;

FIG. 11 is a diagram showing reflection of the change of the character string, at the higher hierarchy layer;

FIG. 12 shows the character string management table;

FIG. 13 is a diagram showing alert character string data being automatically input;

FIG. 14 shows an example of adding and displaying an alert character string and its related information;

FIG. 15 shows a screen example according to the embodiment of the present invention;

FIG. 16 shows a processing flow of the present invention;

FIG. 17 shows an example of a block diagram of computer hardware in a character string aggregation system in numerical aggregation calculation of the present invention;

FIG. 18 shows a flow of calculating a character string ID; and

FIG. 19 shows a flow in the case where character string data is deleted.

### DETAILED DESCRIPTION OF THE SEVERAL VIEWS OF THE DRAWINGS

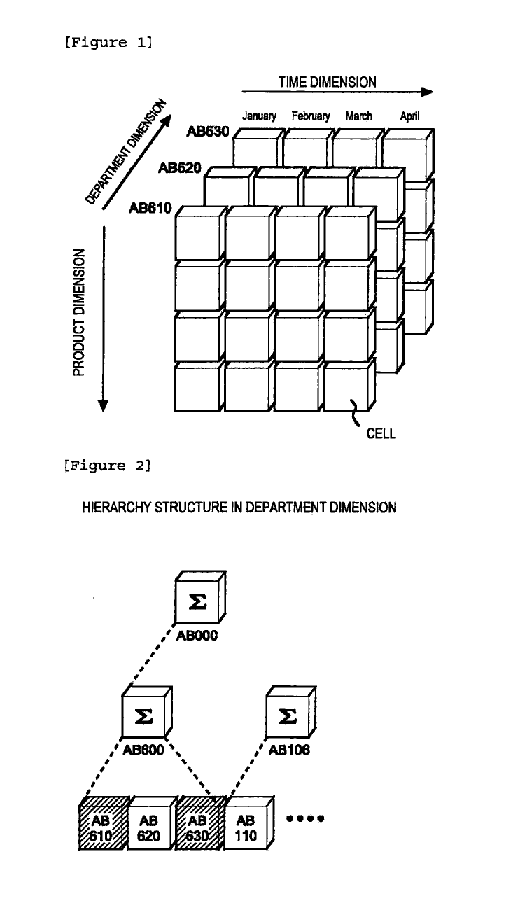

MOLAP is a technique for performing high-speed aggregation calculation/multi-dimensional analysis of numerical data. Since the structure of the MOLAP is well known, description thereof will be omitted. FIG. 1 shows the outline of the MOLAP for simple description. It is assumed that there is a three-dimensional database for which the horizontal direction (X axis), the vertical direction (Y axis) and the depth direction (Z axis) are defined as a time dimension, a product dimension, a department dimension, respectively. In the MOLAP, it is possible to access data of a particular cell by specifying a value of each of the dimensions. It is also possible to give a hierarchy structure relationship. For example, if a hierarchy structure in the department dimension is given, it is possible to calculate the sales of products of the whole department at a high speed. FIG. 2 shows the state of the sum total of cells from the bottom upward in accordance with the department hierarchy. Thus, in the MOLAP, though high-speed aggregation calculation of numerical data is possible, aggregate display of character strings is not possible.

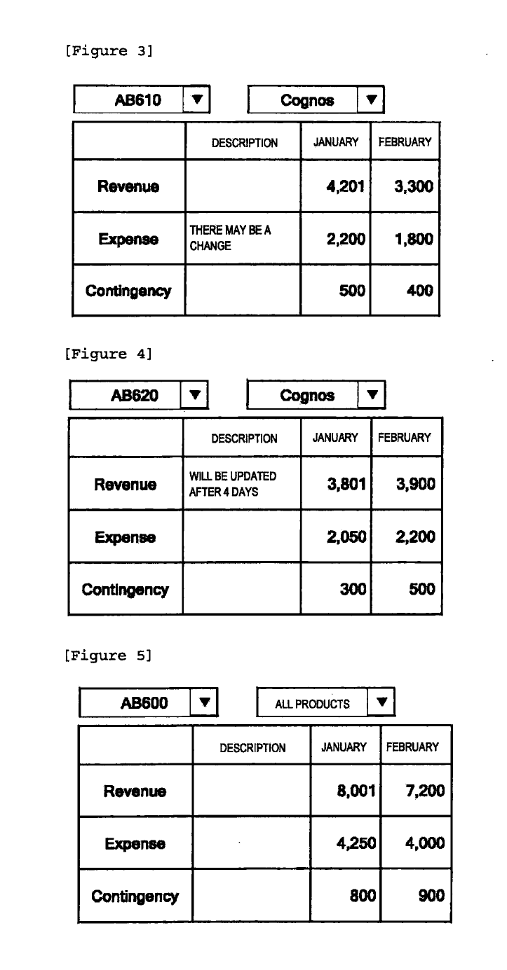

For example, when it is assumed that there is provided a MOLAP description column at a lower hierarchy layer, and an explanation is input in the description column, as in FIGS. 3 and 4, the character data of the lower hierarchy layer is not displayed in a description column at a higher hierarchy layer where data of the lower hierarchy layer are integrated, as in FIG. 5. That is, it is a natural result because, in the MOLAP, aggregation of character string data is not possible though aggregation of numerical values is possible. Two boxes at an upper part in the diagrams shown hereafter exemplify pull-down menus for switching among hierarchy layers. The left box is a menu for making a selection for the department dimension, and the right box is a menu for making a selection for the product dimension. A description field in the diagrams shown hereafter is a character string field stated in the present invention, and character string data is input here.

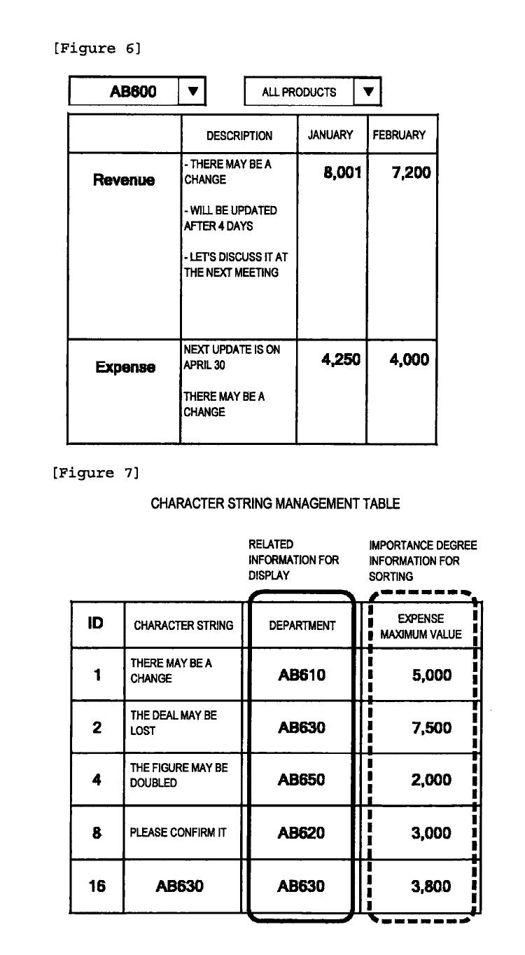

FIG. 6 shows an example of a higher hierarchy layer review screen in the case where it is assumed that character string data of the lower hierarchy layer can be aggregated at the higher hierarchy layer. As can be understood from FIG. 6, it is not possible to judge which character string is important because the character string data are merely aggregated. Furthermore, as character string data to be aggregated increases, all the character string data cannot be displayed in a display area. Even if the character string data can be scrolled, it is very hard to see. Furthermore, because accompanying information of the lower hierarchy layer, for example, information indicating which department a message is from is lost at the time of aggregation, the context of character string data is difficult to understand.

Therefore, in the present invention, character string data held by the lower hierarchy layer are dynamically aggregated and displayed by using numerical calculation of the MOLAP.

The summary of a main process is as follows:

(1) Replacement with numerical values is performed with the use of a character string management table, and numerical aggregation calculation of the MOLAP is used.

(2) Character string information are arranged in order of the degree of importance to narrow down the character string information to the top N pieces of character string information and display them.

(3) The degree of importance of the character string information is calculated on the basis of numerical data included in the view. (Here, an indicator is selectable.)

(4) The number of character strings which cannot be displayed is displayed as “Other x character strings”. (x: the number of character strings)

(5) Related information obtained from a view of the MOLAP is added to the character strings (so that a user can understand the context of the character strings).

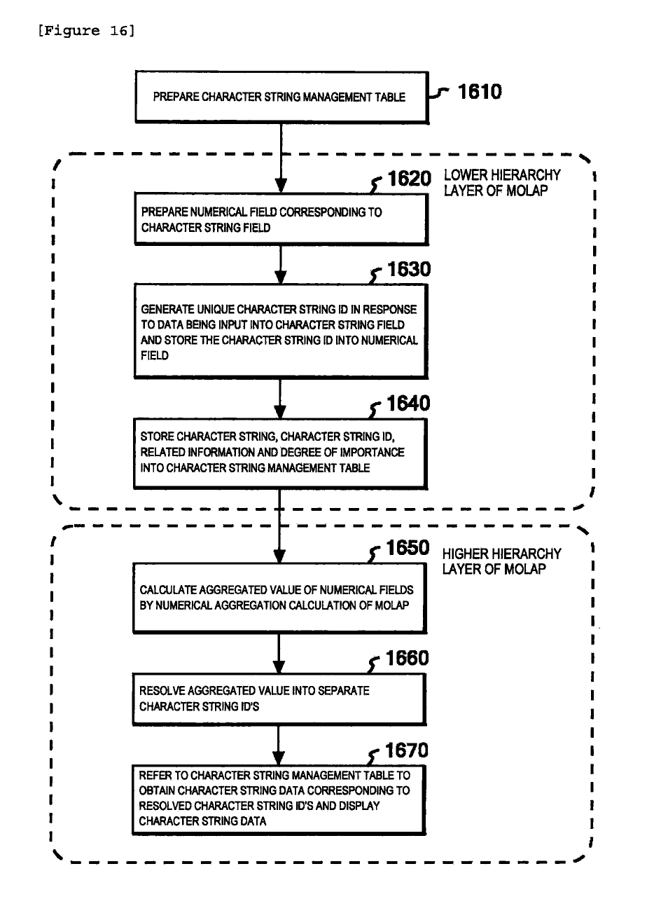

FIG. 16 shows a main process flow in the process of the present invention described above. If the process of the present invention is configured as a program, it functions as a program using numerical calculation of an existing MOLAP program. However, the function of the program may be configured by hardware. First, at step 1610, a character string management table is prepared. The character string management table is a table in which at least character string data and unique character string IDs corresponding to the character string data are recorded.

FIG. 7 shows the structure of the character string management table. The first column is for recording a character string ID, and a number is given each time character string data is input. The second column is for recording character string data itself. The third column is for recording related information. The related information is information related to the character string data, for example, a department code. The fourth column is for recording the degree of importance. The degree of importance indicates the importance of the character string data. The importance may be judged by analyzing the character string itself, or it may be indicated, for example, by a value of sales data.

Next, at step 1620, after setting a character string field on the MOLAP, a numerical field corresponding to this character string field is prepared. Preferably, the numerical field is set to have an invisible attribute.

Next, at step 1630, a character string ID is given to character string data in response to the data being input into the character string field. This character string ID is a value unique to the character string. The value is recorded in the numerical field. In the case of the present invention, this value is calculated by exponentiation with 2 as the base and an integer value as the exponent. For example, the integer value begins with 0 and is incremented by 1 each time a character string is input. Thereby, subsequent resolution into character string IDs can be easily performed. Exponentiation of 2 is merely one aspect, and the calculation method is not limited thereto. Other calculation methods are also possible if an aggregated character string can be resolved into original multiple character strings.

Then, at step 1640, the character string data and the character string ID are stored in the character string management table. The above steps 1620 to 1640 are a process performed at the lower hierarchy layer of the MOLAP.

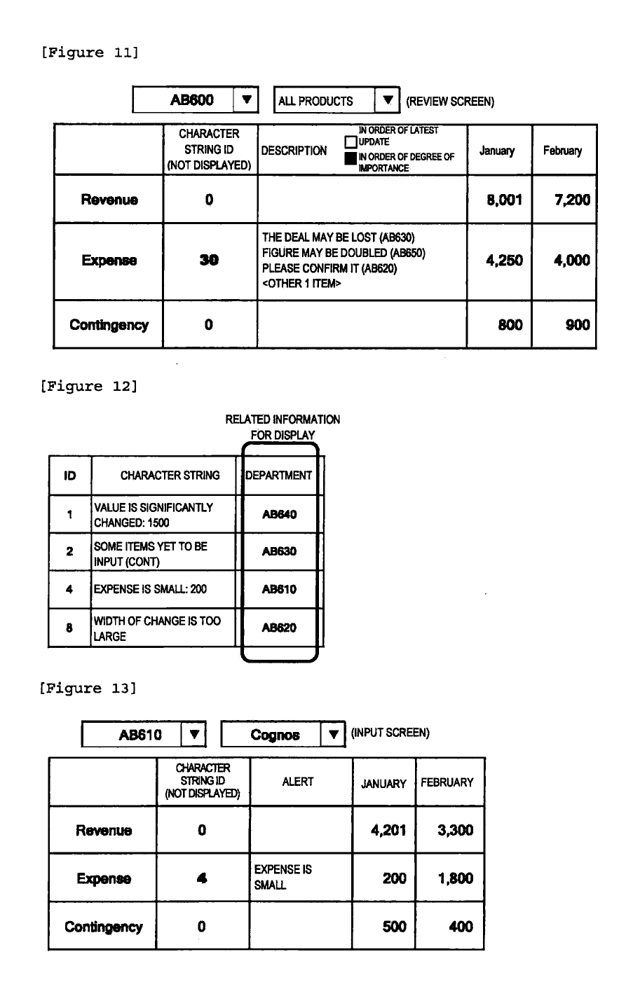

Next, at step 1650, an aggregated value of the numerical fields is calculated by the numerical aggregation calculation of the MOLAP, and the aggregated value is recorded in a numerical field at the higher hierarchy layer. For example, in the case of FIG. 12, 1+2+4+8=15 is recorded.

Then, at step 1660, the aggregated value is resolved into separate character string IDs. By resolving the value in the numerical field of the higher hierarchy layer by exponentiation of 2, the value is resolved into the original multiple character string data. In the case of the above example, the value is resolved into character string IDs of 8, 4, 2 and 1 because of 15=8+4+2+1.

Lastly, at step 1670, the character string management table is referred to, and character string data corresponding to the resolved character string IDs are obtained and displayed. In this case, sorting may be performed in order of the degree of importance so that the character string data is narrowed down to the top N character string data (N: integer) and displayed. As the degree of importance in this case, indicators other than sales data can be selected appropriately. That is, an indicator which is important to a reviewer may be selectable. Related information may be displayed beside a character string. Thereby, the user can understand the context of the character string data. FIG. 15 shows an example of a screen of the higher hierarchy layer according to the embodiment of the present invention.

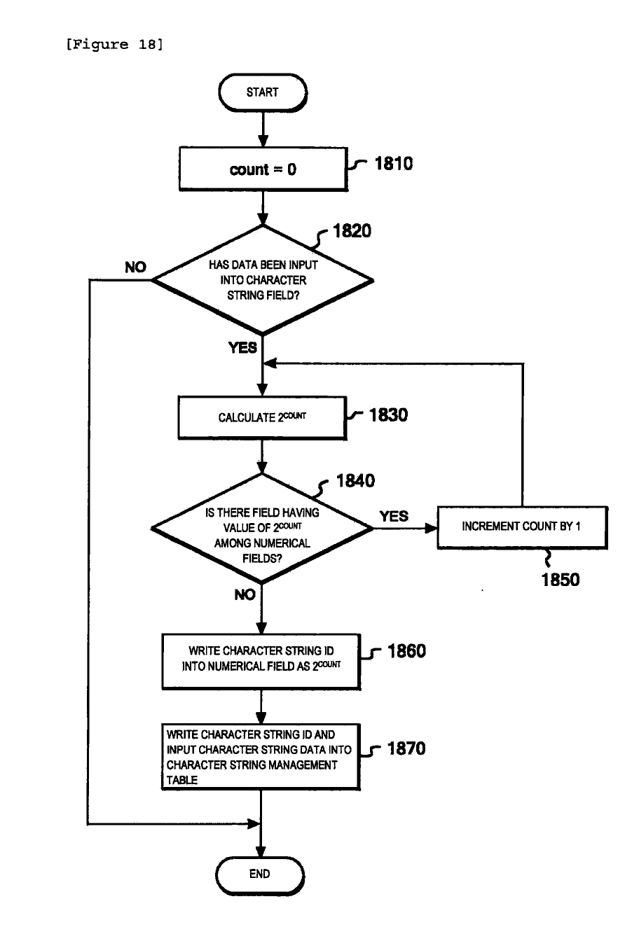

FIG. 18 shows a more detailed flow of steps 1630 to 1640. First, at step 1810, zero is given to a variable for counting of the character string data. Next, at step 1820, it is judged whether data has been input into the character string field. If data has been input, a character string ID is calculated, with 2 as the base and the value of the counting variable as the exponent. Next, at step 1840, it is judged whether the calculated character string ID already exists in the numerical field. If the character string ID exists, the counting variable is incremented by 1 at step 1850, and the flow returns to step 1830. If the character string ID does not exist, the character string ID is written into the numerical field at step 1860. Then, at step 1870, the character string ID and the input character string data are written into the character string management table.

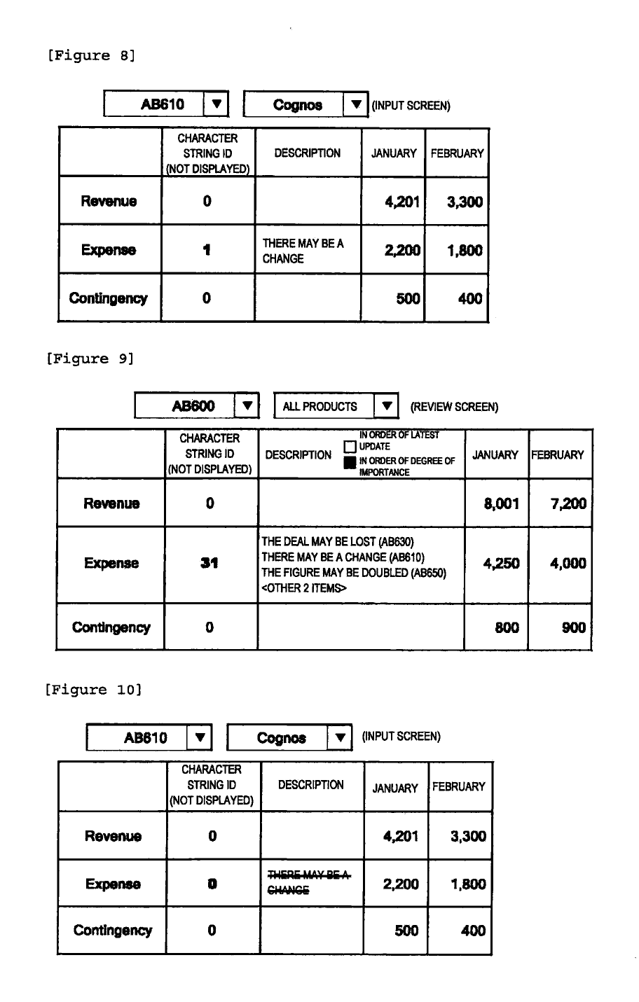

FIGS. 8 and 9 show an example of aggregately displaying character strings using the numerical aggregation calculation. When a character string with a character string ID of 1 is input in FIG. 8, the character string ID on the higher hierarchy layer review screen in FIG. 9 is resolved as shown below.

Resolution of the character string ID value: 31=16+8+4+2+1

Furthermore, sorting is performed in order of the degree of importance to character strings to the top N character strings, the N character strings are displayed, added with related information.

FIG. 10 shows an example of the case where a character string is changed. In FIG. 10, when a character string is deleted at the lower hierarchy layer, the character string ID becomes 0 (zero). Then, on the higher hierarchy layer review screen (FIG. 11), the character string ID is resolved as shown below:

Resolution of the character string ID value: 30=16+8+4+2

Thus, the relevant character string is not displayed. That is, it is possible to dynamically update character string display in response to a change in character string data.

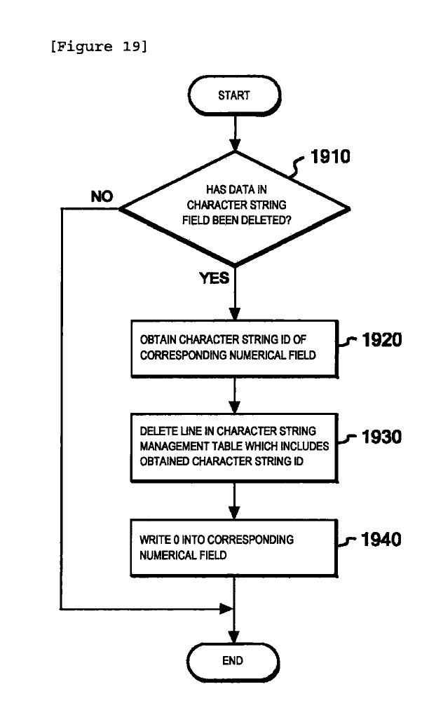

FIG. 19 shows a more detailed flow performed in the case where data in the character string field is deleted. First, at step 1910, it is judged whether data in the character string field has been deleted. If data has been deleted, a character string ID in a corresponding numerical field is obtained at step 1920. Next, at step 1930, a line in the character string management table which includes the obtained character string ID is deleted. Then, at step 1940, zero is written in the numerical field.

As another aspect of the present invention, an example of dynamic aggregate display of alerts will be described. The procedure is as follows:

(1) When numerical data is input at the lower hierarchy layer, it is judged whether the numerical value does not exceed a threshold, and alert character string data is automatically input (FIG. 13).

(2) A character string ID is calculated for the alert character string and recorded in the numerical field. The alert character string and related information are recorded in the character string management table (FIG. 12).

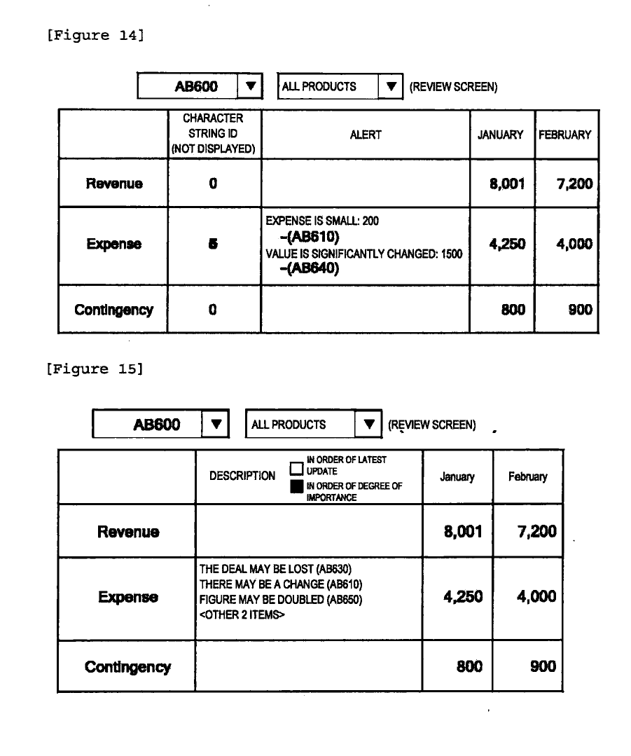

In the example of FIG. 12, there is a cell showing a value of 200 which is smaller than a predetermined value 500. Therefore, a character string of “Expense is small: 200” is automatically created and set as character string data. In addition, it is also possible to set a predetermined value as the maximum width of change so that an alert character string is created when the width of change exceeds the predetermined value. In FIG. 14, there is a cell showing 1500 which exceeds a predetermined change value 1000. Therefore, an alert character string of “Value is significantly changed: 1500” is created and displayed as character string data. In addition, it is also possible to issue alerts such as an alert saying that there is an item not input yet and an alert saying that the width of change is too large.

(3) Numerical aggregation calculation of IDs is dynamically performed by the MOLAP.

(4) A character string ID is resolved at the higher hierarchy layer.

(5) Corresponding character strings and their related information are added and displayed (FIG. 14).

In the example of FIG. 14, the character string ID value is resolved (5=4+1), and a character string value is obtained for each character string ID and displayed with related information added.

<Block Diagram of Computer Hardware>

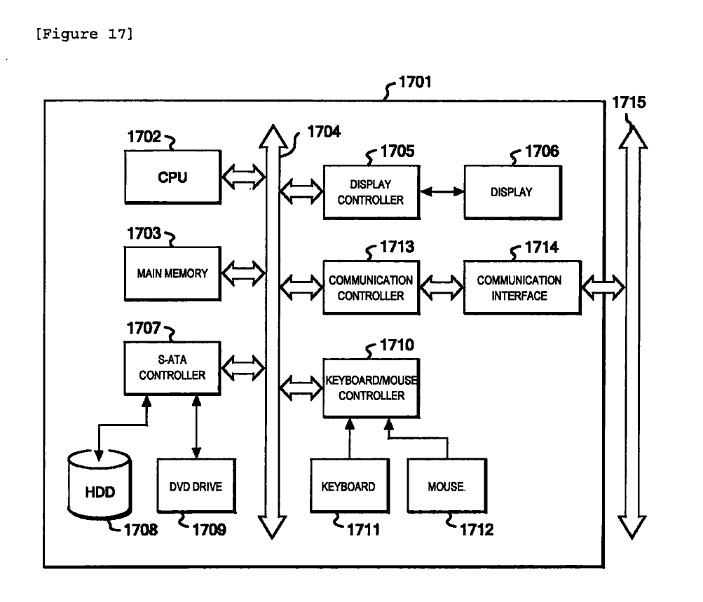

FIG. 17 shows an example of a block diagram of computer hardware in a character string aggregation system in numerical aggregation calculation of the present invention. A computer system (1701) according to the embodiment of the present invention includes a CPU (1702) and a main memory (1703), and these are connected to a bus (1704). The CPU (1702) is preferably based on a 32-bit or 64-bit architecture, and, for example, Xeon™ Series, Core™ Series, Atom™ Series, Pentium™ Series and Celeron™ Series by Intel Corporation, and Phenom™ Series, Athlon™ Series, Turion™ Series and Sempron™ Series by Advanced Micro Devices, Inc., and the like can be used. Alternatively, any type of suitable processing unit or processor units may be used such as, for example, a graphical processing unit, a filed programmable gate array, or system on a chip processor.

To the bus (1704), a display (1706), such as an LCD monitor, is connected via a display controller (1705). The display (1706) is used to input character string data, select an indicator for importance degree information and display the result of MOLAP calculation. To the bus (1704), a hard disk or a silicon disk (1708) and a CD-ROM, DVD or Blur-ray drive (1709) are also connected via an IDE or SATA controller (1707). The program according to the present invention and data may be stored in these storage devices. The program of the present invention, a character string management table and the MOLAP program are stored in the hard disk (1708) or the main memory (1703) and executed by the CPU (1702) to perform desired calculation. The result of MOLAP calculation is displayed on the display (1706). Though the program of the present invention functions using the numerical calculation of the MOLAP program, it is also possible to cause the function to work by hardware.

The CD-ROM, DVD or Blu-ray drive (1709) is used to install programs including the MOLAP program into the hard disk or read data from a CD-ROM, DVD or Blu-ray disk, which is a computer-readable medium as needed. Furthermore, a keyboard (1711) and a mouse (1712) are connected to the bus (1704) via a keyboard/mouse controller (1710).

A communication interface (1714) is in accordance with, for example, the Ethernet™ protocol. The communication interface (1714) is connected to the bus (1704) via a communication controller (1713) and is in charge of physically connecting the computer system and a communication line (1715). The communication interface (1714) provides a network interface layer for the TCP/IP communication protocol, a communication function of the operating system of the computer system. It is also possible to request calculation processing to be performed by external MOLAP, via the communication line.

The character string aggregation method of the present invention can be realized by an object-oriented programming language, such as C++, Java™, JavaBeans™, Java™ Applet, JavaScript™, Perl, Ruby, and an apparatus executable program which is described in a database language such as SQL, and the like. The program can be distributed being stored in a computer-readable recording medium or can be distributed by being transmitted.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention has been described with a particular embodiment and examples. However, the present invention is not limited to the particular embodiment or examples and can be varied within a range that those skilled in the art can conceive. For example, other embodiments, addition, change, deletion and the like are included. Any of the aspects is included in the scope of the present invention as far as the operation and advantages of the present invention are realized thereby.

What is claimed is:

1. A method for aggregating character strings using numerical aggregation calculation of Multi-dimensional On-line Analytical Processing (MOLAP) by computer processing, the method comprising the steps of:
preparing with a processing unit, a character string management table for managing character strings, and a character string field and a numerical field corresponding to the character string field in hierarchy structure data of the MOLAP;
generating, in response to character string data being input into the character string field, a unique character string ID for a character string of the character string data and storing the character string ID into the numerical field;
storing the character string ID and the character string data into the character string management table;
calculating an aggregated value of the numerical fields by the numerical aggregation calculation of the MOLAP at a higher hierarchy layer of the hierarchy structure data;
resolving the aggregated value into separate character string IDs at the higher hierarchy layer; and
referring to the character string management table to obtain and display character string data corresponding to the resolved character string IDs.

2. The method of claim 1, wherein a numerical value of the unique character string ID is a numerical value calculated by exponentiation with 2 as the base and an integer value as the exponent.

3. The method of claim 1, wherein the step of storing the character string and the character string ID into the character string management table further comprises a step of storing importance degree information, wherein the importance degree information is a value of a particular field of the MOLAP.

4. The method of claim 3, wherein the display step further comprises a step of sorting the character string management table in accordance with values of the importance degree and performing display in order of the sorting.

5. The method of claim 4, wherein the display step further comprises a step of displaying the top N character string data (N: integer) in order of the sorting.

6. The method of claim 1, wherein the step of storing the character string and the character string ID into the character string management table further comprises a step of storing related information, wherein the related information is a value of a field related to the input character string.

7. The method of claim 6, wherein the display step further comprises a step of referring to the character string management table to display related information about the character string data corresponding to the resolved character string IDs.

8. The method of claim 1, further comprising a step of, in response to the data input in the character string field being deleted, storing the character string ID into the numerical field as 0.

9. The method of claim 1, wherein, when the length of the input character string exceeds a value predetermined for the field, an alert character string based on the value is created and set as character string data for the character string field.

10. The method of claim 1, wherein the numerical field is an invisible field.

11. An system for aggregating character strings using numerical aggregation calculation of Multi-dimensional On-line Analytical Processing (MOLAP) by computer processing, the system comprising:
a display; and
a processor unit operative to prepare, a character string management table for managing character strings, and a character string field and a numerical field corresponding to the character string field in hierarchy structure data of the MOLAP, generate, in response to character string data being input into the character string field, a unique character string ID for a character string of the character string data and storing the character string ID into the numerical field, store the character string ID and the character string data into the character string management table, calculate an aggregated value of the numerical fields by the numerical aggregation calculation of the MOLAP at a higher hierarchy layer of the hierarchy structure data, resolve the aggregated value into separate character string IDs at the higher hierarchy layer, and refer to the character string management table to obtain character string data corresponding to the resolved character string IDs, and output the character string data corresponding to the resolved character string IDs to the display.

12. The system of claim 11, wherein the unique numerical value is a numerical value calculated by exponentiation with 2 as the base and an integer value as the exponent.

13. The system of claim 11, wherein the storing the character string and the character string ID into the character string management table further includes storing importance degree information, wherein the importance degree information is a value of a particular field of the MOLAP.

14. The system of claim 13, wherein the processor unit is further operative to sort the character string management table in accordance with values of the importance degree and presenting the result on the display in order of the sorting.

15. The system of claim 14, wherein the processor unit is further operative to present the top N character string data (N: integer) in order of the sorting on the display.

16. The system of claim 11, wherein the storing the character string and the character string ID into the character string management table further comprises storing related information, wherein the related information is a value of a field related to the input character string.

17. The system of claim 16, wherein the processor unit is further operative to refer to the character string management table to additionally display related information about the resolved character strings.

18. The system of claim 11, wherein the processor unit is further operative to, in response to the data input in the character string field being deleted, store the character string ID into the numerical field as 0.

19. The system of claim 11, wherein, when the length of the input character string exceeds a value predetermined for the field, an alert character string based on the value is created and set as character string data for the character string field.

20. A computer program product for causing a computer to aggregate character strings using numerical aggregation calculation of Multi-dimensional On-line Analytical Processing (MOLAP), the computer program product comprising:
a computer readable storage medium having computer readable program code embodied therewith, the computer readable program code comprising:
computer readable program code to prepare a character string management table for managing character strings, and a character string field and a numerical field corresponding to the character string field in hierarchy structure data of the MOLAP;
computer readable program code to generate, in response to character string data being input into the character string field, a unique character string ID for a character string of the character string data and storing the character string ID into the numerical field;
computer readable program code to store the character string ID and the character string data into the character string management table;
computer readable program code to calculate an aggregated value of the numerical fields by the numerical aggregation calculation of the MOLAP at a higher hierarchy layer of the hierarchy structure data;
computer readable program code to resolve the aggregated value into separate character string IDs at the higher hierarchy layer; and
computer readable program code to refer to the character string management table to obtain and display character string data corresponding to the resolved character string IDs.
